(19) United States
(12) Patent Application Publication
(10) Pub. No.: US 2011/0279848 A1
(43) Pub. Date: Nov. 17, 2011

(54) IMAGE FORMING APPARATUS WITH POWER SAVE MODE LEARNING FUNCTION AND METHOD OF MANAGING POWER SAVE MODE IN THE IMAGE FORMING APPARATUS

(76) Inventors: Tatsuya WATABE, Osaka (JP); Kei Ohashi, Osaka (JP); Shinsaku Tohki, Osaka (JP)

(21) Appl. No.: 13/106,014

(22) Filed: May 12, 2011

(30) Foreign Application Priority Data
May 13, 2010 (JP) 2010-111007(P)

(51) Int. Cl. G06K 15/00

(52) U.S. Cl. 358/1.13

(57) ABSTRACT

An image forming apparatus includes an auto pattern updating unit for determining transition time for transition from a normal conduction state to a power saving state of each time of day based on job logs, and a display processing unit for displaying the determined state of transition of each time of day on a display unit on hour-by-hour basis. The display device may be an external PC for management, or an operation display panel of the image forming apparatus. For the time of day of which transition time cannot be determined, the shortest time period is allocated. The hour-by-hour transition time is displayed in color-coded manner. The automatically determined transition time may be changed by a user operation.

### CROSS-REFERENCE TO RELATED APPLICATION

This nonprovisional application claims priority under 35 U.S.C. §119(a) on Patent Application No. 2010-111007 filed in Japan on May 13, 2010, the entire contents of which are hereby incorporated by reference.

### BACKGROUND OF THE INVENTION

1. Field of the Invention

The present invention relates to an image forming apparatus provided with an operational mode allowing operation in a so-called power saving manner. More specifically, the present invention relates to an image forming apparatus having a function of automatically learning a time period from completion of a work until transition to the power save mode based on job logs.

2. Description of the Background Art

As one type of image processing apparatuses as electronic equipment, image forming apparatuses forming images on recording paper (typically, copy machines) are introduced to many places of business (companies and offices). In such a place of business, it has become increasingly common to connect an image forming apparatus having a printer function or a copy function to a network, to allow use (sharing) by a plurality of users. A multifunction peripheral (MFP) as one type of such image forming apparatuses has a plurality of basic operational modes such as a copy mode, a facsimile mode (hereinafter “facsimile” may also be denoted as FAX or fax), a network-supported printer mode and a scanner mode. In such an image forming apparatus, each user selects an operational mode and sets a function of duplex (two-sided) printing or collective printing (such as 2-in-1 by which two pages of an original document are printed on one sheet, or 4-in-1 by which four pages of an original document are printed on one sheet), whereby images are formed on sheets of paper in a desired manner. Appropriate combinations of these functions come to be more frequently used.

Consider a digital apparatus including an image forming unit utilizing electro-photographic process as the image forming apparatus. In such an image forming apparatus, a toner image recorded and reproduced on a photoreceptor is transferred to a sheet of recording paper. A heating and fixing unit has a heat source such as a heater, and fixes the toner that has been transferred to the sheet of recording paper on the sheet with prescribed temperature and pressure. Therefore, if an environment that is always ready for image formation is to be provided, it becomes necessary to maintain the heating and fixing unit at a constant temperature. For this purpose, constant control of electric conduction to the heater is required. Such control inevitably increases power consumption. Since a heater consumes much power, it poses a significant problem from the viewpoint of energy saving. Since saving of power consumed at offices is much emphasized recently, constant need of such a high power is undesirable.

In view of the foregoing, conduction control to the heating and fixing unit taking into account the working situation of the image forming apparatus while it is powered on has been considered. By way of example, Japanese Patent Laying-Open No. 8-69222 (hereinafter referred to as '222

Reference) discloses an energy saving technique in which electric conduction to the fixing unit is limited to reduce power consumption of the image forming apparatus during hours when the apparatus is not frequently used.

However, if the electric conduction to the heating and fixing unit is limited too much, a problem arises that even when electric conduction to the heating and fixing unit is started to form an image, the image cannot be formed immediately. This is because the temperature of heating and fixing unit has been lowered. Until the heating and fixing unit reaches a prescribed temperature, image formation is impossible, and the user is kept waiting. Therefore, it is not a preferable approach to cut conduction to the heating and fixing unit in a very short time after the end of an operation of the image forming apparatus.

It is noted that the apparatus is busily operated in some hours, while it is seldom used and kept in a standby state for a long period in other hours of the day. There is a margin for further reducing the power consumption, if the working situation of the image forming apparatus is carefully monitored and the time until conduction to the heating and fixing unit is cut is determined appropriately.

As a solution to such a problem, Japanese Patent Laying-Open No. 10-149052 (hereinafter referred to as '052 Reference) discloses an image forming apparatus in which the working situation of the apparatus is managed hour by hour, and transition time to the power save mode is adjusted depending on whether it is busy hours with frequent use or off-peak hours of seldom use.

FIG. 1 shows an example of hour-by-hour wait time of an image forming apparatus. FIG. 2 shows an exemplary variation of the number of jobs and the number of sheets of paper output per hour. As can be seen from FIGS. 1 and 2, the wait time, the number of output sheets and the number of jobs per hour show constant patterns. These patterns, however, may differ department by department where the image forming apparatus is used, or they may vary seasonally. The patterns may also change depending on the day of the week.

In the image forming apparatus disclosed in '052 Reference, in order to cope with such variations, the image forming apparatus itself is controlled such that the time until the image forming apparatus enters a suspended state is made shorter if the wait time per hour is long and the time until it enters the suspended state is made longer if jobs are executed at a relatively high frequency. Such a manner of control lowers the possibility that the image forming apparatus is in the suspended state at the start of use and it takes long time until an image is formed.

The image forming apparatus disclosed in '052 Reference attains preferable effects that power consumption can be reduced without lowering operational efficiency. The apparatus, however, still has problems to be solved.

The first problem is that it becomes difficult for the user to understand the behavior of the image forming apparatus, since the image forming apparatus automatically learns the time until it enters the suspended state. Sometimes the apparatus soon enters the suspended state, and at other times, it takes long until it enters the suspended state, depending on the time of day. The user cannot know how the time is adjusted. Therefore, it is difficult for an administrator to efficiently manage the image forming apparatus disclosed in '052 Reference.

The second problem occurs when the image forming apparatus has been used for a certain time period at a certain department and as a result learned the time to enter the suspended state appropriate for the department. If the image forming apparatus is moved to another department, the learned result may not be appropriate for the new department. The operational setting will not be optimized for the department at least for a while.

From the viewpoint of management, there is still another problem that appropriate setting of the image forming apparatus is difficult even if significant change in the manner of use of the image forming apparatus is expected according to the development of business operations.

### SUMMARY OF THE INVENTION

Considering the problems above, it is desirable to provide an image forming apparatus allowing the administrator to efficiently carry out power saving management. It is more desirable if it is possible to easily confirm what settings are made for power saving. It is more desirable if it is possible not only to confirm but also to set the apparatus to maintain the power saving effect if the installation location of the apparatus is changed or if the power is turned on at a time of day when the power is usually off.

According to a first aspect, the present invention provides an image forming apparatus, including: a transition time determining unit determining, based on working situation of the image forming apparatus at an installation location, transition time of each time slot of a day for making a transition from a normal conduction state to a power saving state; and a display control unit displaying the status of each time slot determined by the transition time determining unit, slot by slot on a display device.

The transition time automatically determined by the transition time determining unit is displayed hour by hour by the display control unit. Since the automatically set transition time can be confirmed, it becomes possible for the administrator to efficiently manage the image forming apparatus.

Preferably, the display device is a display device of external equipment communicable with the image forming apparatus.

Since the hour-by-hour transition time is displayed on the display device of external equipment, it is possible for the administrator of the apparatus to manage the image forming apparatus from the outside.

The image forming apparatus may further include an operation display panel, and the display device may be the operation display panel.

More preferably, the transition time determining unit includes a selection determining unit determining the transition time of each time slot to one selected from a predetermined plurality of time periods, based on the working situation of the image forming apparatus at the installation location; and for a time slot for which the transition time cannot be determined by the selection determining unit, the shortest time period among the plurality of time periods is determined to be the transition time.

The determination of transition time may possibly fail at times, for example, if the power supply to the image forming apparatus is off, or logs cannot be obtained. In such a situation, the shortest of a plurality of time periods is allocated as the transition time. That the power supply is off means it is the time of day when the frequency of use of the image forming apparatus is low. Therefore, even if the power supply is turned on, the transition time is made the shortest, to attain the power saving effect.

More preferably, the display control unit displays the determined status of each time slot in color-coded manner.

Since the determination status of hour-by-hour transition time is displayed in color-coded manner, visual recognition is easy and the working situation and the determination status of transition time of the apparatus can readily be confirmed.

Preferably, the image forming apparatus further includes a post-display changing unit for changing, after the transition time determined by the transition time determining unit is displayed by the display control unit, the transition time of each time slot in accordance with a user operation.

Since the transition time can be changed automatically and manually, it can be modified so as not to lower the power saving effect, even if the installation location of the apparatus is changed and the situation becomes different from the past working situations.

The image forming apparatus may further include a changing unit for changing the transition time of each time slot.

According to another aspect, the present invention provides a method of managing power saving setting of an image forming apparatus, including the steps of: determining, based on working situation of the image forming apparatus at an installation location, transition time of each time slot of a day for making a transition from a normal conduction state to a power saving state; and displaying the status of each time slot determined at the transition time determining step, slot by slot on a display device.

Preferably, the display device is a display device of external equipment communicable with the image forming apparatus.

More preferably, the image forming apparatus further includes an operation display panel, and the display device is the operation display panel.

More preferably, the step of determining the transition time includes the step of determining the transition time of each time slot to one selected from a predetermined plurality of time periods, based on the working situation of the image forming apparatus at the installation location, and for a time slot for which the transition time cannot be determined at the step of determining to selected one, the shortest time period among the plurality of time periods is determined to be the transition time.

Preferably, at the step of displaying on the display device, the determined status of each time slot is displayed in color-coded manner.

More preferably, the method further includes the step of changing, after the transition time determined at the transition time determining step is displayed at the displaying step, the transition time of each time slot in accordance with a user operation.

More preferably, the method further includes the step of changing the transition time of each time slot.

As described above, according to the present invention, the determination status of hour-by-hour transition time determined by the transition time determining unit is displayed hour by hour on the display device. Since the automatically determined transition time can be confirmed, it becomes possible for the administrator to efficiently manage the image forming apparatus. The display device may be a display device of external equipment, or it may be an operation display panel of the image forming apparatus. The image forming apparatus can be managed efficiently from a location convenient for the administrator. For the time of day when the transition time cannot be determined, the shortest among the plurality of time periods is allocated as the transition time. Therefore, even if the power of image forming apparatus is turned on at such a time of day, the power saving effect can still be attained. By displaying the determination status hour by hour in color coded manner, the working situation and the determination status of transition time of the apparatus can readily be confirmed at one sight. By providing the changing unit for changing the hour-by-hour transition time by the user operation, it becomes possible to maintain the power saving effect even when the installation location of the apparatus is changed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a graph showing an example of hour-by-hour wait time of an image forming apparatus.

FIG. 2 is a graph showing an exemplary variation of the number of jobs and the number of sheets of paper output per hour of the image forming apparatus.

FIG. 3 schematically shows an example of visually friendly display of the operational modes of the image forming apparatus in accordance with an embodiment of the present invention.

FIG. 4 is a perspective view showing an appearance of the image forming apparatus in accordance with the embodiment of the present invention.

FIG. 5 schematically shows an internal configuration of the image forming apparatus shown in FIG. 4.

FIG. 6 is a functional block diagram showing hardware configuration of the image forming apparatus shown in FIG. 4.

FIG. 7 schematically shows an exemplary configuration of a network system including image forming apparatus 100 shown in FIG. 4.

FIG. 8 is a functional block diagram showing functions related to the operational mode for energy saving, in image forming apparatus 100.

FIG. 9 shows examples of job logs recorded in image forming apparatus 100.

FIG. 10 is a flowchart representing a control structure of a program for displaying the result of learning of energy saving operation pattern in image forming apparatus 100.

FIG. 11 shows an example of energy saving setting screen image of image forming apparatus 100.

FIG. 12 is a flowchart representing a control structure of a program for visually displaying time change of energy saving operation patterns, including the result of learning of energy saving operation patterns and operational modes set by the user.

FIG. 13 is a flowchart representing a control structure of a program for registering, in accordance with a user instruction, whether image forming apparatus 100 is to be operated in accordance with a schedule of an automatically learned energy saving operation pattern, or a schedule set by the user.

FIG. 14 is a flowchart representing a control structure of a program for saving a user pattern, which is a schedule of energy saving operation pattern prepared by the user in image forming apparatus 100.

FIG. 15 is a flowchart representing a control structure of a program for updating contents of energy saving settings to be displayed on the screen image in accordance with a user selection in image forming apparatus 100.

FIG. 16 is a flowchart representing a control structure of a program for updating display in accordance with result of modification, when the user modifies the user pattern in image forming apparatus 100.

FIG. 17 is a flowchart representing a control structure of a program for automatically learning an energy saving operation pattern of image forming apparatus 100, based on the job logs of a past prescribed time period of image forming apparatus 100.

### DESCRIPTION OF THE PREFERRED EMBODIMENTS

In the following description, the same components are denoted by the same reference characters. Their names and functions are also the same. Therefore, detailed description thereof will not be repeated.

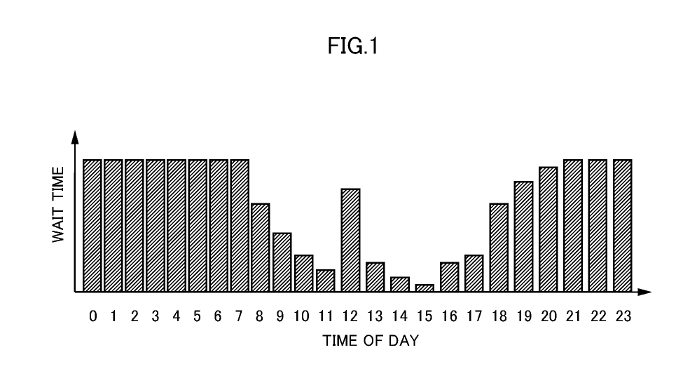

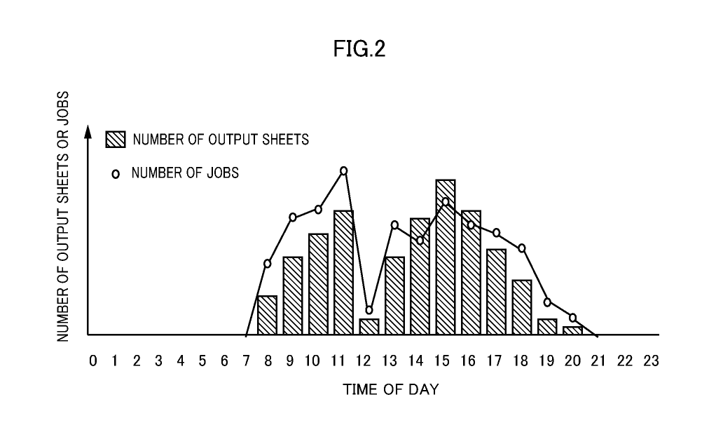

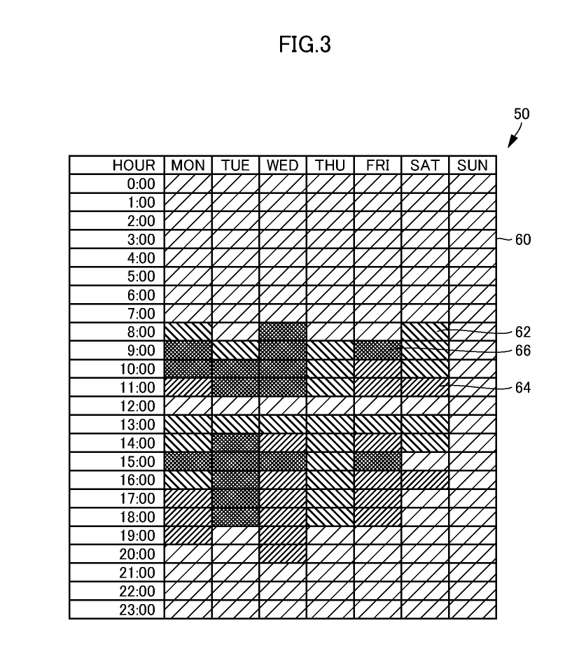

As described with reference to FIGS. 1 and 2, working situation of the image forming apparatus in accordance with an embodiment of the present invention differs department by department, hour by hour and day by day of the week. Therefore, the time until the heating and fixing unit enters the suspended state also differs hour by hour, day by day of the week and department by department where the image forming apparatus is installed. Therefore, similar to the technique of '052 Reference, the image forming apparatus in accordance with the present embodiment automatically learns the energy saving operation pattern based on the hour-by-hour and day-by-day working situations. In order to solve the problem of the prior art that it is difficult for the user to know how the apparatus behaves, in the image forming apparatus in accordance with the present embodiment, the results of learning are displayed in a manner easy for the user to understand, in the form of Table 50 shown in FIG. 3.

Referring to FIG. 3, Table 50 is a two-dimensional table. In Table 50, the abscissa represents days of the week and the ordinate represents 24 hours of the day, sectioned hour by hour.

In the present embodiment, each cell represents, by the color of display of the cell, the energy saving operation pattern set for the corresponding day of the week and the time of day. Since FIG. 3 is not in color presentation, different colors are represented by different hatchings. For example, a cell 66 indicates the “high-performance” mode representing the highest frequency of use, and it is displayed in red. A cell 64 indicates the “performance” mode, in which image forming apparatus 100 is used with rather high frequency, though not as high as in the “high-performance” mode, and it is displayed in pink. A cell 62 indicates a time of day when the frequency of use is lower (“balance”) than the time of “performance” mode, and it is displayed in pale blue. A cell 60 indicates a time of day when the frequency of use is the lowest (“power save”), and it is displayed in green. Since the cells are displayed in different colors, the four energy saving patterns can clearly be understood visually. Table 50 may be displayed on a touch-panel display 130 of image forming apparatus 100 or on a display of a personal computer (hereinafter referred to as a “PC”) 190 for the administrator, and the administrator can easily and intuitively understand how the image forming apparatus 100 is working.

If the energy saving operation pattern is “high performance,” the time period after the heating and fixing unit of image forming apparatus stopped the operation until a pre-heat mode is entered (hereinafter this time period will be referred to as a “transition time”) is set to be the longest, and in “performance,” the transition time is set to be the second longest. In “balance” mode, the transition time is far shorter to shut off than in the “performance” mode, and in “power save,” it takes the shortest time to shut off after the end of operation. Such settings of transition time in the present embodiment will be described in detail later.

The image forming apparatus forms an image on a sheet of recording paper utilizing electro-photography. The image forming apparatus includes, as operational modes, copy mode, FAX mode, document filing mode (a mode in which a scanned image is stored in a storage device in the image forming apparatus) and mail mode (a mode in which a scanned image is transmitted attached to an electronic mail). The image forming apparatus may further include network printer mode. The printing method is not limited to electro-photography, provided that it includes a member such as the heating and fixing unit that takes relatively long time until it becomes operable again, once it enters the suspended state.

[Image Forming Apparatus: Function]

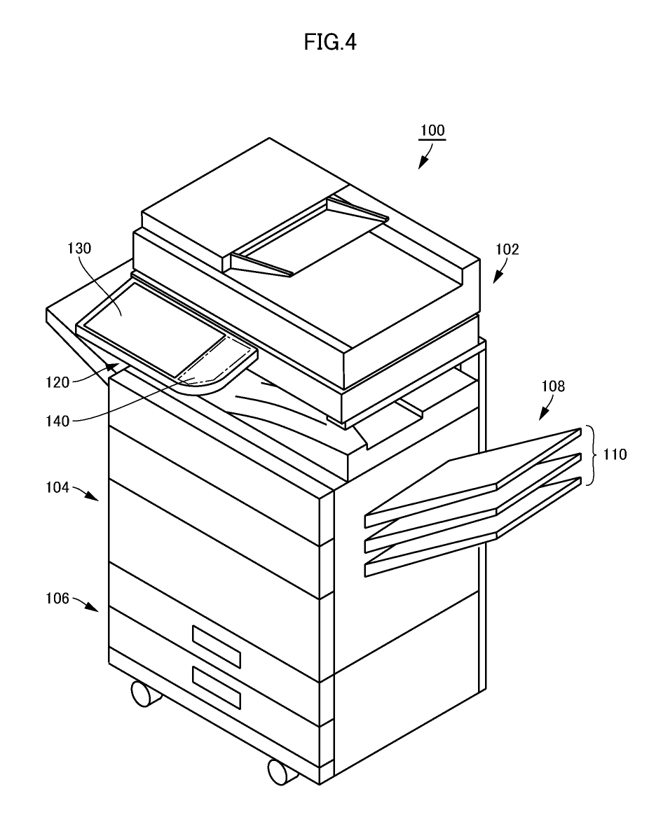

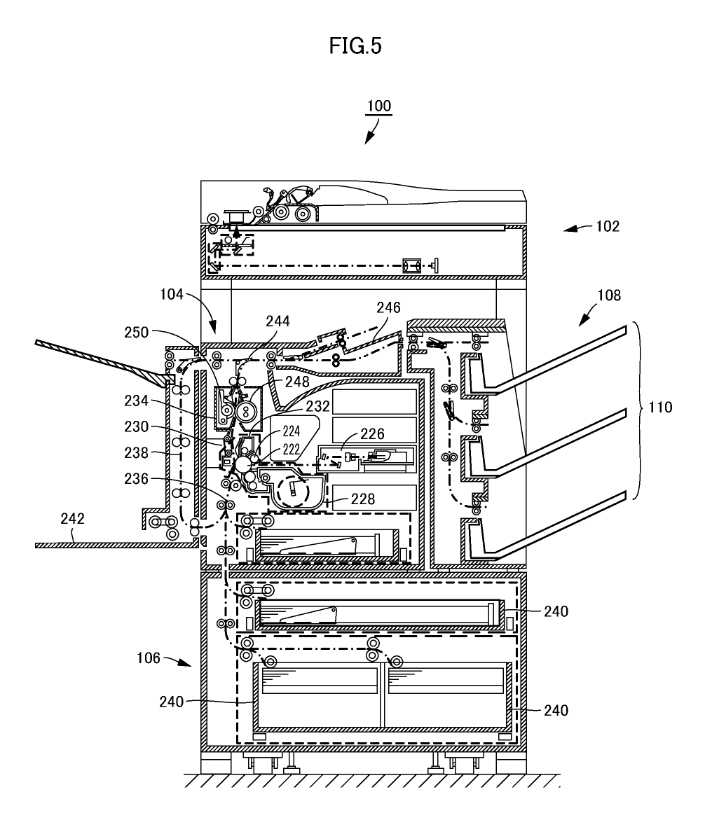

Referring to FIGS. 4 to 6, an image forming apparatus 100 in accordance with the present embodiment will be described.

Referring to FIGS. 4 to 6, image forming apparatus 100 includes a document reading unit 102, an image forming unit 104, a paper feed unit 106, a paper discharge unit 108 and an operation unit 120. Operation unit 120 includes a touch-panel display 130 and an operation key unit 140, as shown in FIG. 4. Touch-panel display 130 includes a display panel 132 formed of a liquid crystal panel or the like, and a touch-panel 134 arranged on display panel 132, for detecting a position pressed by the user's finger. On operation key unit 140, a number of function keys and ten-keys are arranged, not shown.

The operational modes of image forming apparatus 100 as such will be described.

—Copy Mode—

In the following, an operation in the copy mode will be described. In the copy mode, mainly document reading unit (also referred to as a scanner unit) 102 and image forming unit 104 operate.

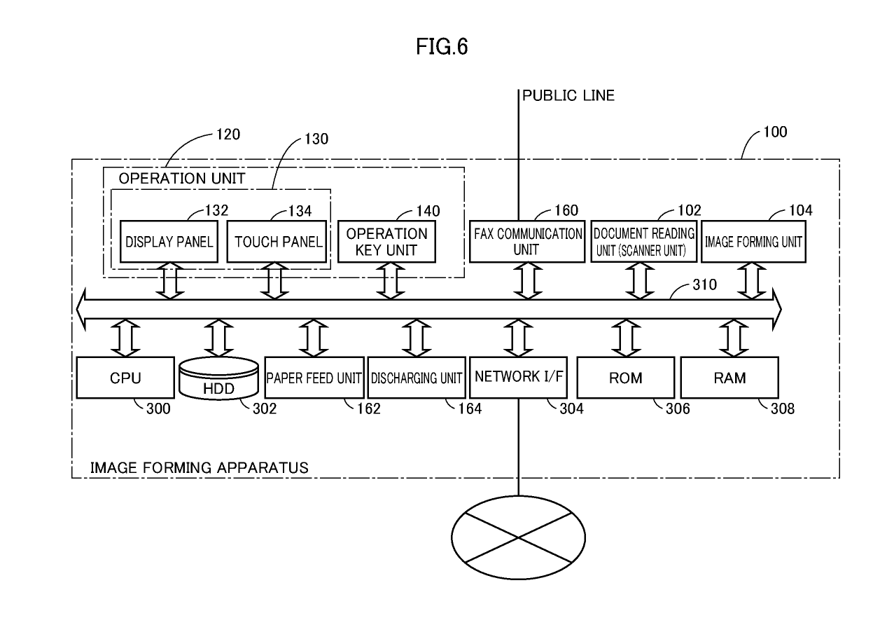

In image forming apparatus 100, a document placed on a platen is read by document reading unit 102 as image data. The read image data is input to CPU (Central Processing Unit) 300 implemented, for example, by a microcomputer shown in FIG. 6. The image data is subjected to various image processing operations here, and the resulting image data is output to image forming unit 104.

Image forming unit 104 is for printing an image of the document represented by the image data on a recording medium (in most cases, on a sheet of recording paper). Image forming unit 104 includes a photoreceptor drum 222, a charger 224, a laser scanning unit (hereinafter denoted as LSU) 226, a developer 228, a transfer device 230, a cleaning device 232, a fixing device 234 and a neutralizer, not shown. Fixing device 234 as the heating and fixing unit is provided with a heater or the like, not shown. The heater or the like maintains the temperature of fixing device 234 at a constant temperature even when image forming apparatus 100 is in the standby state. It is noted, however, that if a prescribed time period passes in the standby state, image forming apparatus 100 enters the energy saving operational mode. The present embodiment addresses how to determine, how to display or how to modify the wait time until the apparatus enters the energy saving operational mode (that is, the transition time) here.

In image forming unit 104, a main feeding path 236 and a reverse feeding path 238 are provided, and a sheet of recording paper fed from paper feed unit 106 is fed along main feeding path 236. Paper feed unit 106 draws out sheets of recording paper stacked on a paper feed cassette 240 or on a manual feed tray 242 one by one, and feeds the sheet of paper to main feeding path 236 of image forming unit 104.

While the sheet of recording paper is fed along main feeding path 236 of image forming unit 104, the sheet passes between photoreceptor drum 222 and transfer device 230, and further passes through fixing device 234, whereby printing is done on the sheet of recording paper.

Photoreceptor drum 222 rotates in one direction, and its surface is cleaned by cleaning device 232 and the neutralizer and, thereafter, uniformly charged by charger 224.

LSU 226 modulates the laser beam based on the image data to be printed, and repeatedly scans the surface of photoreceptor drum 222 with the modulated laser beam in a main scanning direction, whereby an electrostatic latent image is formed on the surface of photoreceptor drum 222.

Developer 228 develops the electrostatic latent image by supplying toner to the surface of photoreceptor drum 222, and thus, a toner image is formed on the surface of photoreceptor drum 222.

Transfer device 230 transfers the toner image on the surface of photoreceptor drum 222 to the sheet of recording paper passing between transfer device 230 and the photoreceptor drum 222.

Fixing device 234 includes a heating roller 248 and a pressure roller 250. Heating roller 248 is for heating the sheet of recording paper. Pressure roller 250 is for pressing the sheet of recording paper. As the sheet of recording paper is heated by heating roller 248 and pressed by pressure roller 250, the toner image that has been transferred to the sheet of recording paper is fixed on the sheet. A heater is heated by electric power supplied to fixing device 234 and controlled such that temperature of heating roller 248 attains to an appropriate temperature for fixing. When operational mode is changed to the energy saving mode, power supply to the heater is, for example, stopped or reduced.

At a position of connection between main feeding path 236 and reverse feeding path 238, a separation pawl 244 is arranged. When printing is done only on one side of the sheet of recording paper, separation pawl 244 is so positioned that the sheet of recording paper fed from fixing device 234 is guided to paper discharge tray 246 or a paper discharge unit 108.

When printing is done on both sides of the sheet of recording paper, separation pawl 244 is turned to a prescribed direction, so that the sheet of recording paper is guided to reverse feeding path 238. The sheet of recording paper passes through reverse feeding path 238, turned upside-down and again fed to main feeding path 236, and while it is again fed along main feeding path 236, printing is done on its rear surface, and thereafter the sheet is guided to paper discharge tray 246 or to paper discharge unit 108.

The sheet of recording paper printed in the above-described manner is guided to paper discharge tray 246 or to paper discharge unit 108, and discharged to paper discharge tray 246 or to any of paper discharge trays 110 of paper discharge unit 108.

Paper discharge unit 108 may perform a process of sorting a plurality of printed sheets of paper to be output to different discharge trays 110, a process of punching each sheet of recording paper or a process of stapling the sheets of recording paper. Assume that a number of copies of the printing are to be prepared. In that case, sheets of recording paper are sorted and discharged to paper discharge trays 110 such that each tray 110 contains each set of printed sheets, and the set of printed sheets in each tray 110 is stapled or punched.

—Facsimile Mode—

In the following, an operation in the facsimile mode will be described. In the facsimile mode, the facsimile function is realized by transmission and reception operations. In the transmission operation, document reading unit (scanner unit) 102 and FAX communication unit 160 mainly operate. In the reception operation, FAX communication unit 160 and image forming unit 104 mainly operate.

Transmission Operation

In image forming apparatus 100, the facsimile mode is designated. A document placed on the platen is read by document reading unit 102 as image data. The read image data is input to CPU 300 implemented, for example, by a microcomputer shown in FIG. 6, the image data is subjected to various image processing operations here, and the resulting image data is output to a FAX communication unit (FAX communication unit 160 of FIG. 6).

FAX communication unit 160 of image forming apparatus 100 on the transmitting side connects a designated transmitting side line to a designated transmission destination. After connection, FAX communication unit 160 converts the image data to communication data in compliance with facsimile transmission standard, and transmits the converted data to a facsimile machine (such as an image forming apparatus having the facsimile function) on the receiving side.

Communication Operation

When the line is connected, a FAX communication unit of the image forming apparatus on the receiving side detects a communication request signal from FAX communication unit 160 of image forming apparatus 100 on the transmitting side, and transmits an acknowledgement signal. Thereafter, by way of example, FAX communication units on the transmitting and receiving sides pass performance information supported by transmitting side and receiving side, determine highest possible speed of communication and method of coding/code correction of image data, and set the method of communication of modems. Then, using the image signal format in compliance with the communication method, data is transmitted from FAX communication unit 160 of image forming apparatus 100 on the transmitting side to the FAX communication unit of image forming apparatus on the receiving side. When transmission ends, the line is disconnected.

Reception Operation

When image forming apparatus 100 is on the receiving side, FAX communication unit 160 converts the received data to image data and passes the data to an image forming unit 104. The received data may be converted to image data at the image forming unit 104. The image forming unit 104 prints an image of a document represented by the image data converted from the received data on a sheet of recording paper, in a manner similar to the operation in the copy mode described above.

—Document Filing Mode—

In the following, an operation in the document filing mode will be described. In the document filing mode, mainly document reading unit (scanner unit) 102 and image forming unit 104 operate.

In image forming apparatus 100, a document placed on the platen is read by document reading unit 102 as image data. The read image data is input to CPU 300 and subjected to various image processing operations here. The resulting image data is stored in a storage device (hard disk drive 302 as will be described later) provided in image forming apparatus 100.

The stored image data is read from the hard disk drive by the user designating the file name, and printed on a sheet of recording paper in the similar manner as in the copy mode described above.

—Mail Mode (Scan-to-Mail)—

In the following, description will be given on an operation in the mail mode. In the mail mode, document reading unit (scanner unit) 102 and network interface (I/F) 304 mainly operate.

The image communication mode provided in image forming apparatus 100 includes the facsimile mode and the electronic mail communication mode (mail mode). In the facsimile mode, image data is transmitted/received by public line through FAX communication unit 160 as described above. In the electronic mail communication mode (mail mode), the image data is transmitted/received by the Internet line in the form of an attachment to an electronic mail, through network I/F 304. Image forming apparatus 100 may further include Internet facsimile mode or image transfer mode (scan-to-PC folder). In the Internet facsimile mode, the image data is transmitted/received by the Internet line through network I/F 304. In the image transfer mode (scan-to-PC folder), the image data is transferred to a folder of a specific PC using a network line.

In image forming apparatus 100, a document placed on a platen is read by document reading unit 102 as image data. The read image data is input to CPU 300, and subjected to various image processing operations here. The resulting image data is transmitted, attached to an electronic mail.

Different from the facsimile mode in which a telephone number of transmission destination is designated, a mail address of the transmission destination is designated in the mail mode.

[Image Forming Apparatus: Control Block Configuration]

Referring to FIG. 6, image forming apparatus 100 further includes operation unit 120, ROM (Read Only Memory) 306, a hard disk drive (hereinafter denoted as HDD) 302, and an RAM (Random Access Memory) 308. Operation unit 120 allows setting of functions related to the copy mode, facsimile mode, document filing mode and mail mode. Operation unit 120 also serves as an operation display panel. ROM 306 stores programs and the like. HDD 302 is a non-volatile storage area capable of storing programs and data even when power is cut off. RAM 308 provides a storage area when a program is executed.

Image forming apparatus 100 further includes a bus 310 and CPU 300. Document reading unit 102, image forming unit 104, FAX communication unit 160, operation unit 120, ROM 306, HDD 302, RAM 308, and CPU 300 are connected to bus 310. CPU 300 realizes general functions as the image forming apparatus by executing programs stored in HDD 302 or the like.

Image forming apparatus 100 further includes a paper feed unit 162 and a paper discharge unit 164. Paper feed unit 162 is capable of communication with each of the units of image forming apparatus 100 through bus 310, and executes paper feed control related to image forming unit 104 in accordance with commands from CPU 300. Similar to paper feed unit 162, paper discharge unit 164 is also connected to bus 310 and executes control of discharging sheets of recording paper from image forming unit 104 in accordance with commands from CPU 300.

HDD 302 stores files of image data of documents scanned by image forming apparatus 100, folder by folder, together with date and time of saving and name of the user who saved. Further, HDD 302 stores initial screen image data of each operational mode.

ROM 306 stores programs and data necessary for controlling operations of image forming apparatus 100. The initial screen image data of each operational mode may be stored as data to be stored together with the program in ROM 306. CPU 300 controls image forming apparatus 100 in accordance with the programs and data stored in ROM 306, and executes control related to various functions of image forming apparatus 100.

As shown in FIG. 6, a public line is connected for transmitting/receiving image data, to FAX communication unit 160 of image forming apparatus 100. To network I/F 304, a network line is connected. To the network line, a computer or the like using image forming apparatus 100 as a network-supported printer may be connected. To the network line, a computer or the like identified by a URL (Uniform Resource Locator) designated through the Internet may be connected. When connected to the Internet, image forming apparatus 100 can obtain necessary information through the Internet. As will be described later, the results of learning of energy saving operation patterns in image forming apparatus 100 can be confirmed, modified or added by a computer for the administrator on the network.

RAM 308 provides a function of a working memory for temporarily storing results of operations and processes by CPU 300, and a function of a frame memory for storing image data.

CPU 300 controls document reading unit 102, image forming unit 104, ROM 306, HDD 302, RAM 308 and touch-panel display 130 and display operation key unit 140 forming operation unit 120, by executing a prescribed program or programs. Operation unit 120 communicates with CPU 300 through an input/output I/F.

Operation unit 120 is formed of a plate-shaped panel provided in an inclined manner to be easily viewable by the user. On a surface of operation unit 120, touch-panel display 130 is provided on the left side area, and operation key unit 140 is provided on the right side area. Touch-panel display 130 and operation key unit 140 form operation unit 120 as one integrated body as a whole.

As described above, touch-panel display 130 is formed of display panel 132 and touch-panel 134 arranged on display panel 132. On display panel 132 of touch-panel display 130, a home screen image allowing selection of an operational mode of image forming apparatus 100, current state of image forming apparatus 100, status of destination designation, and status of job processing are displayed. On a display area of display panel 132, selection buttons as software buttons are displayed. When a portion where the selection button is displayed is pressed, the pressed position is detected by the touch-panel 134. By comparing the display position of the selection button and the position where the touch-panel 134 is pressed using a program, selection of an operational mode, setting of a function, and instruction of an operation of image forming apparatus 100 become possible. In addition to such a touch operation (command input operation based on the position of pressing by the user), image forming apparatus 100 also allows gesture operation (command input operation based on trajectory of operation by the user).

In the following, the process for learning energy saving operation patterns in image forming apparatus 100 will be described. Image forming apparatus 100 automatically learns the energy saving operation patterns based on job logs. In addition, image forming apparatus 100 displays the results of learning in an easy-to-understand manner to the user, allows the user to set an energy saving operation pattern, displays the set user mode and the results of learning in an easy-to-understand manner, and allows advance registration of a plurality of different energy saving operation patterns that can be set by the user.

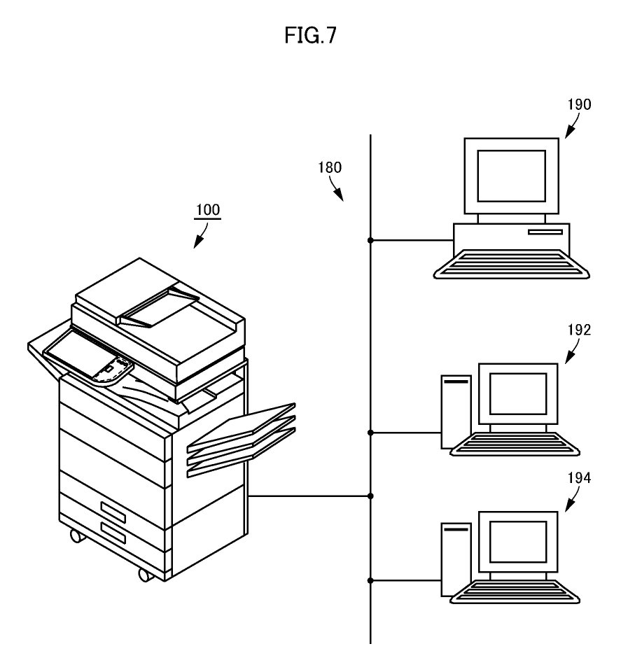

Referring to FIG. 7, generally, image forming apparatus 100 communicates with a plurality of PCs 190, 192 and 194 through network 180, and performs a print process in response to a print request therefrom. Image forming apparatus 100 performs a process for transmitting a scanned image to a specific server, or transmitting it as a mail to a desired mail address. Here, for easier understanding, description of these known features not related to the setting of energy saving operation patterns will not be repeated.

In FIG. 7, it is assumed that PC 190 is for the administrator of image forming apparatus 100, and PCs 192 and 194 are for general users. Display and change of settings of energy operation patterns in accordance with Table 50 described with reference to FIG. 3 may be realized through operation unit 120 of image forming apparatus 120. It may be convenient if the display and change of settings can be done from PC 190 for the administrator. Such a process is also possible in image forming apparatus 100.

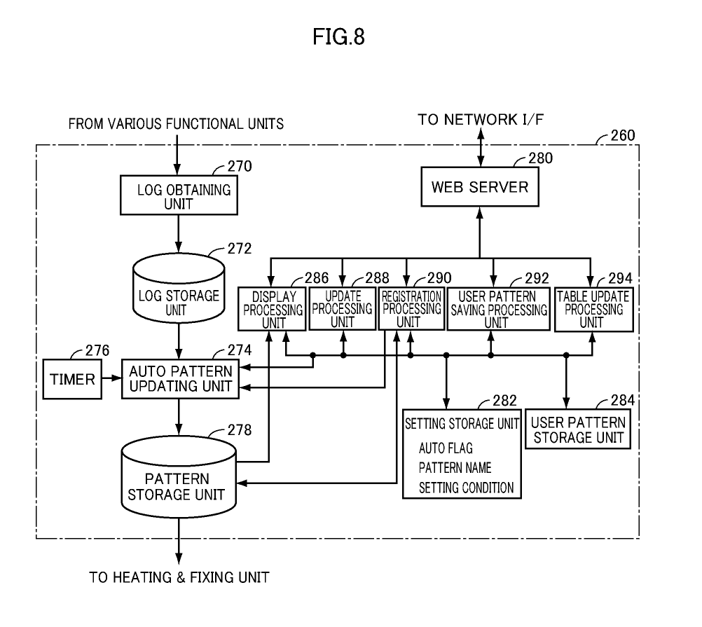

FIG. 8 shows, as energy saving setting unit 260, only the functional portions related to the energy saving operational mode for energy saving settings, extracted from image forming apparatus 100. Referring to FIG. 8, energy saving setting unit 260 includes a log obtaining unit 270, a log storage unit 272, an auto pattern updating unit 274, a timer 276, and a pattern storage unit 278. Log obtaining unit 270 obtains operation records of various functional units of image forming apparatus 100 as job logs. Log storage unit 272 stores the job logs obtained by log obtaining unit 270. Auto pattern updating unit 274 is activated by an externally applied trigger, and based on the job logs of a past prescribed period stored in log storage unit 272, automatically updates the schedule of energy saving operation pattern of image forming apparatus 100. Timer 276 periodically (for example, at 0:00 a.m. every day) triggers the schedule changing process by auto pattern updating unit 274. Pattern storage unit 278 stores the schedule pattern of the energy saving operation pattern formed or updated by auto pattern updating unit 274, and applies it to the heating and fixing unit of image forming unit 104.

The energy saving operation pattern in accordance with the present embodiment is given in four stages on day-by-day, hour-by-hour basis, as will be described later. These stages are represented by numerical values 1, 2, 3 and 4. The energy saving operation pattern includes seven records corresponding to the days of the week. Each record consists of the name (identifier) of the energy saving operation pattern to which it belongs, a value indicating the day of the week, and a set of values representing hour-by-hour energy saving operation patterns. By way of example, in the record of Monday shown in FIG. 3, the hour-by-hour energy saving operation patterns are represented by “1, 1, 1, 1, 1, 1, 1, 1, 2, 4, 4, 3, 1, 2, 2, 4, 2, 3, 3, 3, 1, 1, 1, 1.” At the time of shipment, if the energy saving operation pattern is not yet determined, the value representing the energy saving operation pattern is set to 0.

Log storage unit 272, pattern storage unit 278 and the like may be implemented by HDD 302 shown in FIG. 6.

Energy saving setting unit 260 further includes a web server 280 connected to network I/F 304. Web server 280 operates in image forming apparatus 100 so that setting related to various functions of image forming apparatus 100 can be done on browser base from an external PC. Web server 280 has a function of allocating, in response to various and many requests applied from outside, processes to appropriate programs or processing units in accordance with parameters associated with each request, and returning a web document as a result of processing to the browser. Here, for the simplicity of description, among the functional blocks processing requests applied from outside through web server 280, only the functional blocks related to the setting of energy saving operation patterns are shown.

Energy saving setting unit 260 further includes a display processing unit 286, an update processing unit 288, and a registration processing unit 290. Display processing unit 286 receives a request asking what pattern the energy saving operation pattern schedule has in image forming apparatus 100, from outside through web server 280. In response to the request, display processing unit 286 reads the energy saving operation pattern schedule set in image forming apparatus 100 at present from pattern storage unit 278, forms a web document for visual display, and returns the same. Update processing unit 288 receives a request asking a change of contents of the schedule displayed on an external PC, from outside through web server 280. Update processing unit 288 forms a web document for visually displaying the schedule of energy saving operation pattern determined in response to the request and returns the same. Registration processing unit 290 receives a request for setting a pattern of energy saving operation pattern schedule of image forming apparatus 100 from outside through web server 280. In response to the request, registration processing unit 290 writes the set pattern in pattern storage unit 278.

Energy saving setting unit 260 further includes a user pattern saving processing unit 292, a table update processing unit 294, a user pattern storage unit 284, and a setting storage unit 282. User pattern saving processing unit 292 receives a request related to a process of the user forming a pattern of energy saving operation schedule using an external PC, through web server 280. If saving of the pattern formed by the user is designated, user pattern saving processing unit 292 saves the pattern in a computer readable format. While the user forms a pattern of energy saving operation schedule on an external PC, table update processing unit 294 forms and returns a web document for rewriting display of the energy saving operation schedule on the external PC in accordance with the user input, through web server 280. User pattern storage unit 284 stores the user pattern saved by user pattern saving processing unit 292, with a pattern name of each user pattern. Setting storage unit 282 stores settings related to the energy saving operation pattern of image forming apparatus 100, including: an auto flag indicating whether it is an operational mode in which image forming apparatus 100 automatically learns the energy saving operation pattern; pattern name, if the schedule of the energy saving operation pattern at present is a user pattern; and what process is to be carried out if a job log does not exist for a certain time of the day. Setting storage unit 282 can be referred to from each of the units of energy saving setting unit 260. Each functional block operates based on setting information stored in setting storage unit 282. Pieces of information stored in setting storage unit 282 include a method of calculating operating rate used for determining the transition time, and a rule of how to determine the energy saving pattern based on the operating rate.

Table 1 below shows the method of calculating the operating rate in accordance with the present embodiment. Table 2 shows the calculated operating rates, the energy saving pattern names adopted in accordance with the operating rates, and the operations (transition time and state after transition) corresponding to respective energy saving patterns.

TABLE 1

| | Number of | | |
|---|---|---|---|
| | output | Number of | |
| Operating rate | sheets/hour | jobs/hour | Wait time/hour |
| High | 300 or more | 24 or more | Shorter than |
| | | | 10 min. |
| Somewhat high | 50 to 300 | 12 to 24 | 10 to 30 min. |
| Middle | 10 to 50 | 6 to 12 | 30 to 50 min. |
| Low | 10 or smaller | 6 or smaller | 50 min. or longer |

TABLE 2

| Pattern name | Operation | Operating rate |
|---|---|---|
| High performance | Enter preheat mode | High |
| | after 1 hour | |
| Performance | Enter preheat mode | Somewhat high |
| | after 30 minutes | |
| Balance | Shut off after 5 minutes | Middle |
| Power save | Shut off in shortest | Low |
| | period after job end | |

Auto flag of 1 indicates the auto mode, and 0 indicates manual mode. Preferably, the default value of auto flag is 1. The reason for this is that after the apparatus is actually installed, until it becomes possible for the administrator to grasp the working situation, automatic learning of the energy saving operation pattern is desirable.

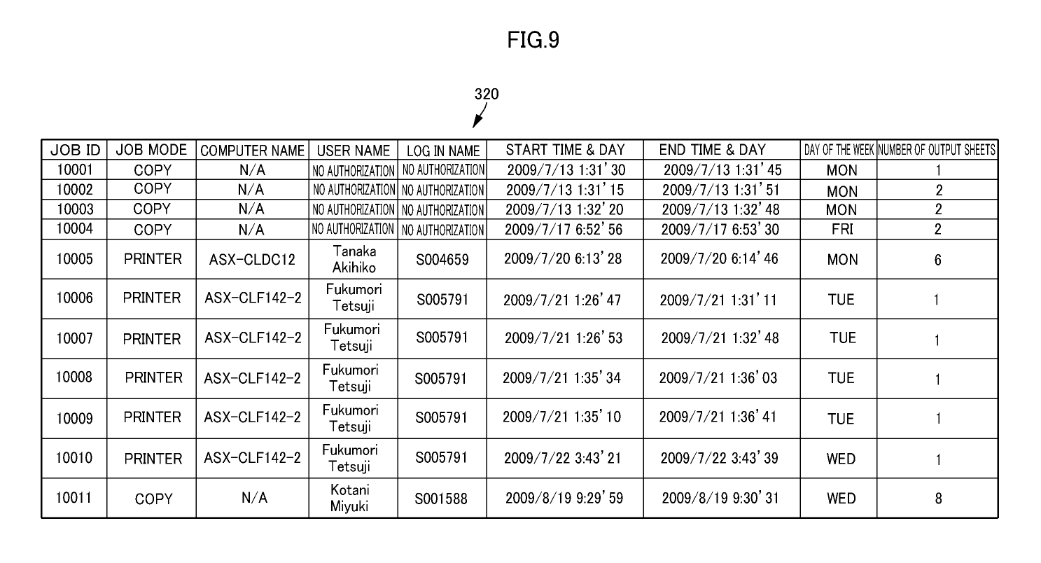

Referring to FIG. 9, job logs 320 stored in log storage unit 272 generally record, job by job, a job ID (identifier), a job mode, a computer name that entered the job and its user name, log-in name of the user, job-start date and time, job-end date and time, job-start day of the week, and the number of sheets of recording paper printed by the job. The function of storing job logs 320 as such is provided not only in image forming apparatus 100 but also in general image forming apparatuses as a standard function. Such job logs are used, for example, when the image forming apparatus fails, to confirm the operations by that time and to find any cause of failure. Further, the job logs are used for determining a new type of apparatus for the next replacement, taking into consideration what functions are of high importance, or for examining which user uses the image forming apparatus at what frequency and consumes how many sheets of recording paper. In the present embodiment, job logs 320 as such are utilized for learning the energy saving operation pattern.

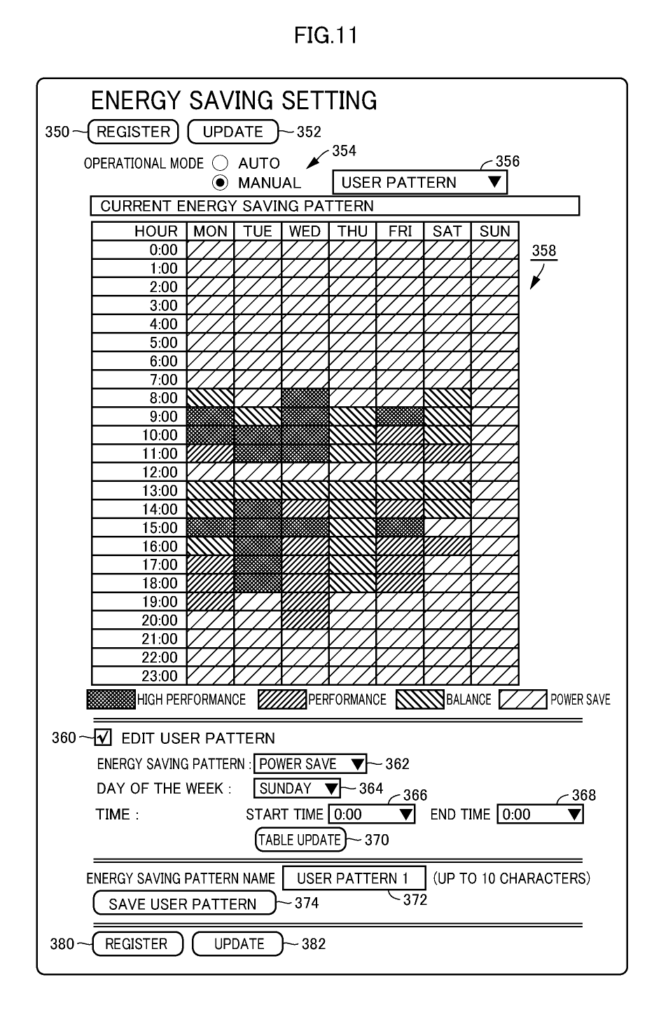

FIG. 11 shows an energy saving setting screen image for setting the energy saving operation pattern in image forming apparatus 100 in accordance with the present embodiment. Referring to FIG. 11, the energy saving setting screen image includes a registration button 350, an update button 352, mode selection radio buttons 354, and a pull-down list 356 for setting a user pattern name, displayed at a header portion. The energy saving setting screen image further includes an energy saving operation pattern table 358 displayed at a center portion. Energy saving operation pattern table 358 visually displays, in the similar manner as Table 50 shown in FIG. 3, the energy saving operation pattern set at present in image forming apparatus 100.

At a tail portion of energy saving setting screen image, a check box 360, a pull-down list 362 for selecting the energy saving mode, a pull-down list 364 for selecting day of the week, a pull-down list 366 of start time, a pull-down list 368 of end time, and a table update button 370 are displayed. Check box 360 is for allowing the user to set whether or not the user pattern is to be edited. Pull-down lists 362, 364, 366 and 368 are each activated if check box 360 is checked. The table update button 370 issues an instruction to update the display of energy saving operation pattern table 358 in accordance with conditions designated by these elements. Below these elements, a pattern name field 372, a user pattern save button (hereinafter also referred to as a save button) 374, a registration button 380, and an update button 382 are further displayed. When a user pattern is to be saved, the user inputs the pattern name in pattern name field 372. Save button 374 is used for instructing that the user pattern is to be saved.

In the following, for the simplicity of description, only an example in which the energy saving operation pattern of image forming apparatus 100 is set from an external PC through web server 280 will be described. It is possible to set the energy saving operation pattern through interactive processing using touch-panel display 130 in image forming apparatus 100, based on exactly the same approach as will be described in the following. When a browser is activated by touch-panel display 130 of image forming apparatus 100 and web server 280 is accessed, a program for setting in a stand-alone environment in image forming apparatus 100 is unnecessary.

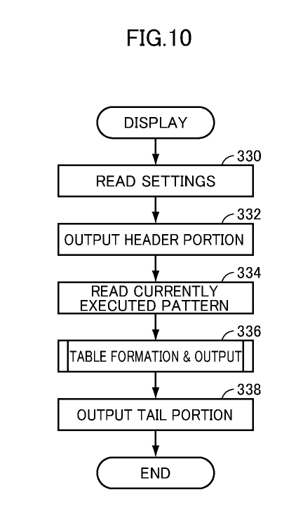

Referring to FIG. 10, a program realizing display processing unit 286 shown in FIG. 8 is called and activated from a menu image displayed when web server 280 of image forming apparatus 100 is logged-in. The program includes the following steps. At step 330, CPU 300 reads a setting related to the energy saving operation pattern among settings of image forming apparatus 100, from setting storage unit 282 shown in FIG. 8. At step 332, CPU 300 outputs the header portion of the screen image shown in FIG. 11. At step 334, CPU 300 reads the schedule of energy saving operation pattern that is currently executed by image forming apparatus 100, from pattern storage unit 278. At step 336, CPU 300 forms and outputs a document for displaying energy saving operation pattern table 358 of FIG. 11, based on the information read at step 334. At step 338, CPU 300 outputs the tail portion of the screen image shown in FIG. 11, and the program ends.

In the present embodiment, the program is configured such that the document transmitted by the program through web server 280 to the PC becomes a web document. The screen image shown in FIG. 11 can be displayed on the PC using a common web browser.

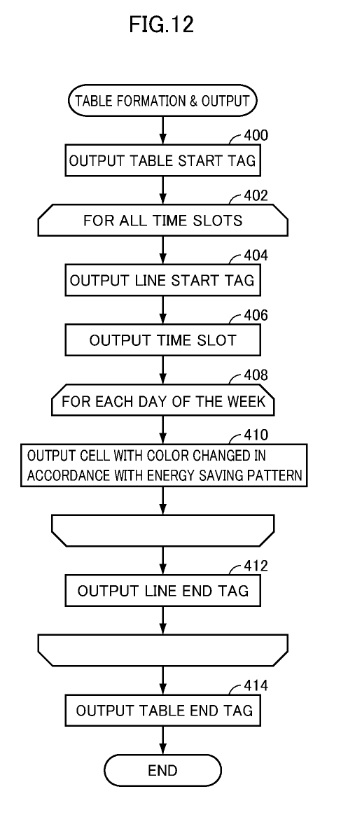

Referring to FIG. 12, a program routine of step 336 shown in FIG. 10 is also called by a program different from the program shown in FIG. 10 and, therefore, it is described as a subroutine here. If this process is to be realized by a script-type programming language, it is preferred that the program corresponding to this portion is prepared as an independent file and at the time of execution, the script in the file is included in another program.

The program includes the following steps. At step 400, CPU 300 outputs a table start tag in the web document, so as to display energy saving operation pattern table 358. At step 402, CPU 300 forms the table body, by repeating steps 404, 406, 408, 410 and 412 for all hours. At step 414, after the end of repetition of step 402, CPU 300 outputs a table end tag, and the program ends.

The process executed for each hour at step 402 includes the following steps. At step 404, CPU 300 outputs a start tag of a line displaying information of hour. At step 406, CPU 300 outputs characters indicating the hour. At step 408, CPU 300 repeats the following step 410 for each day of the week from Monday to Sunday, to form a piece of information representing one line of the table related to a specific hour. At step 412, CPU 300 outputs a line end tag indicating end of the line formed by step 408. At step 410, CPU 300 outputs a start tag and an end tag for each cell. Here, it embeds, in the start tag, a piece of information designating cell width to a fixed value and a piece of information designating background color of the cell in accordance with the energy saving operation pattern allocated to the combination of day of the week and time of the day corresponding to the cell.

By executing the program shown in FIG. 12, display of energy saving operation pattern table 358 such as shown in FIG. 11 can be realized.

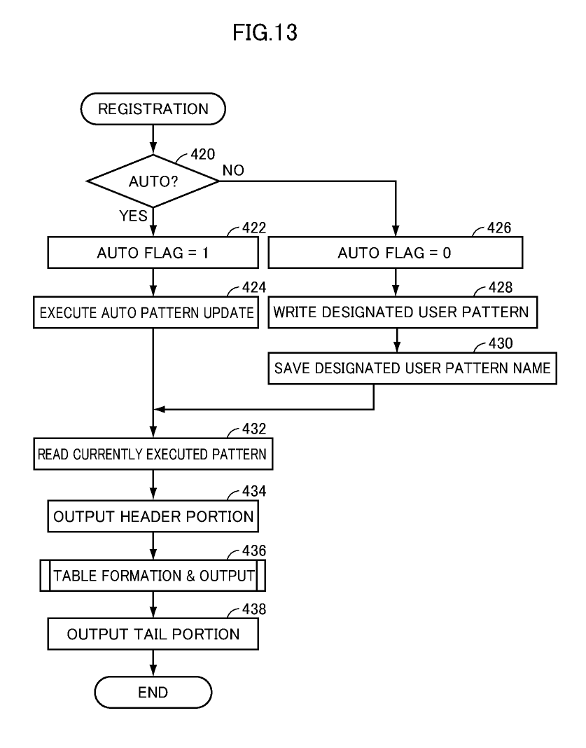

The registration program shown in FIG. 13 is activated by web server 280 when registration button 350 or registration button 380 shown in FIG. 11 is pressed. Here, the parameter set for each element on the screen image of FIG. 11 is passed as an argument to the program. The argument includes a piece of information indicating whether the auto mode or manual mode is designated as the operational mode, a user pattern name selected when the manual mode is designated, and a flag (state of check box 360) indicating whether or not the user pattern is to be edited. The argument further includes an energy saving pattern name (result of selection of pull-down list 362 for selecting energy saving mode), day of the week (result of selection of pull-down list 364 for selecting day of the week), start time (start-time pull-down list 366) and end time (end-time pull-down list 368) of the hour as the object of setting, which are rendered valid if check box 360 is checked. The information of pattern name field 372 is not passed to the program.

The registration program includes the following steps. At step 420, CPU 300 determines, based on the argument, whether the auto mode or manual mode is designated. If the auto mode is designated, at step 422, CPU 300 stores 1 in the auto flag of setting storage unit 282, and at step 424, it executes the auto pattern update process (process by auto pattern updating unit 274 of FIG. 8), whereby the energy saving operation pattern is updated based on the latest job log.

The program further includes the following steps. If it is determined at step 420 that the operational mode is not auto, CPU 300 stores 0 in the auto flag of setting storage unit 282 of FIG. 8 at step 426. At step 428, based on the argument, CPU 300 reads the user pattern designated by the user from user pattern storage unit 284 of FIG. 8 and writes it to pattern storage unit 278. At step 430, CPU 300 stores the pattern name of the written user pattern in setting storage unit 282.

In this program, after steps 424 and 430, control flows are merged. Thereafter, at step 432, CPU 300 reads the energy saving operation pattern that is being executed, stored in setting storage unit 282. In accordance with the results and the setting conditions stored in setting storage unit 282, at step 434, CPU 300 outputs the header portion of energy saving setting screen image shown in FIG. 11. At step 436, CPU 300 forms energy saving operation pattern table 358. At step 438, CPU 300 outputs the tail portion, and the program ends. What is executed at step 436 is the program shown in FIG. 12.

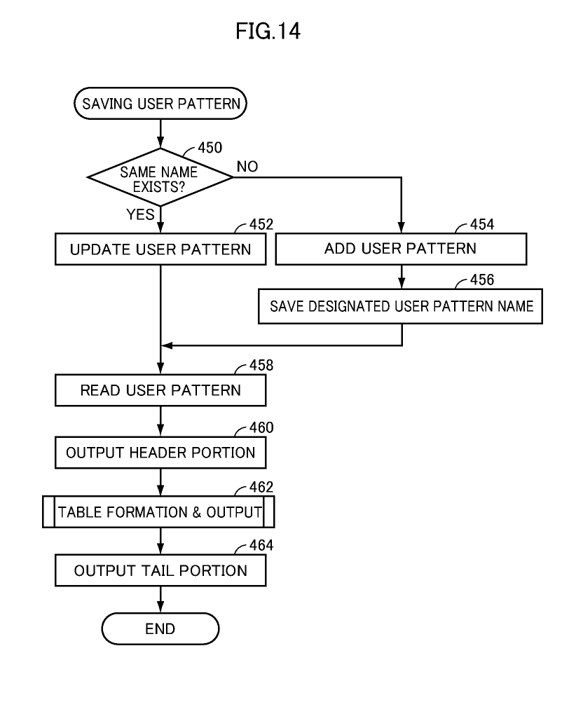

The user pattern saving program shown in FIG. 14 is called by web server 280 when save button 374 is pressed on the energy saving setting screen image of FIG. 11. The arguments passed to this program include a specific value of the energy saving pattern corresponding to the displayed energy saving operation pattern table 358, and the user pattern name input to pattern name field 372.

The program includes the following steps. At step 450, CPU 300 determines, based on the argument (user pattern name), whether or not the user pattern of the same name is stored in user pattern storage unit 284 (see FIG. 8). If the same name exists, at step 452, CPU 300 updates the user pattern of the name, that is, the user pattern of the same name as the user pattern name of the argument (input user pattern name) using the pattern displayed by energy saving operation pattern table 358. If the same name does not exist, at step 454, CPU 300 adds the pattern displayed by energy saving operation pattern table 358, having the user pattern name as the argument (input user pattern name) attached, to pattern storage unit 284. At step 456, CPU 300 saves the added user pattern name to an index area of user pattern storage unit 284.

In this program, after steps 452 and 456, control flows are merged. Thereafter, at step 458, CPU 300 reads the user pattern updated at step 452 or the user pattern added at step 454, from user pattern storage unit 284. At step 460, CPU 300 outputs the header portion using the user pattern. At step 462, CPU 300 performs the process for forming and outputting the table. At step 464, CPU 300 outputs the tail portion, and the program ends. As a result of these process steps, the user pattern of which saving is designated by the user is saved in user pattern storage unit 284, and on the energy saving setting screen image, energy saving operation pattern table 358 in accordance with the saved user pattern is displayed.

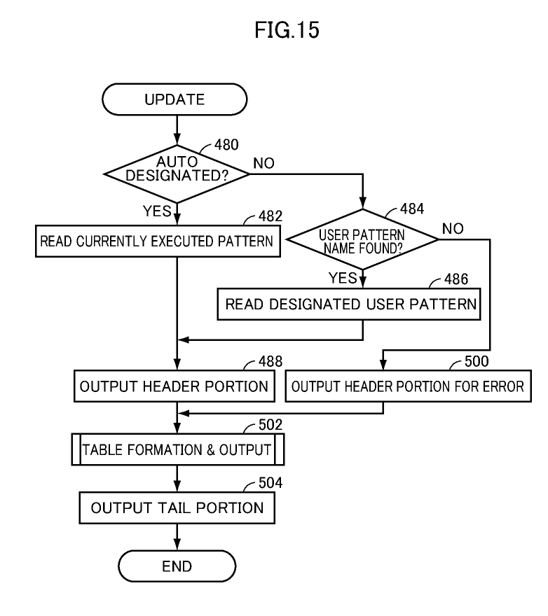

Referring to FIG. 15, the program realizing update processing unit 288 shown in FIG. 8 is activated when update button 352 or update button 382 shown in FIG. 11 is pressed. The program includes the following steps. At step 480, CPU 300 determines, based on the argument determined by mode selection radio button 354, whether the designated operational mode is the auto mode or manual mode. If the designated mode is auto mode, at step 482, CPU 300 reads the energy saving operation pattern that is currently being executed from pattern storage unit 278. If the designated operational mode is manual mode, at step 484, CPU 300 determines presence/absence of user pattern name as the argument from pull-down list 356 for setting the user pattern name. If any user pattern name exists, at step 486, CPU 300 reads the corresponding user pattern from user pattern storage unit 284.

In this program, after steps 482 and 486, the control flows are merged. Thereafter, at step 488, CPU 300 outputs the header portion. Thereafter, at step 502, CPU 300 forms and outputs the table, and at step 504, outputs the tail portion. Then, the program ends.

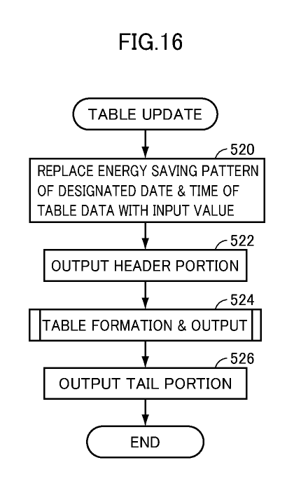

Referring to FIG. 16, the program realizing table update processing unit 294 of FIG. 8 is activated when table update button 370 of energy saving setting screen image of FIG. 11 is pressed. In the energy saving setting screen image shown in FIG. 11, pull-down list 362 for selecting the energy saving mode, pull-down list 364 for selecting day of the week, start-time pull-down list 366, end-time pull-down list 368 and table update button 370 are activated only when check box 360 is checked. If check box 360 is not checked, these are not active. Therefore, table update button 370 will not be pressed, and the program of FIG. 16 will not be executed. When the program is activated, the table data, energy saving pattern name, day of the week, start time and end time as the basis for energy saving operation pattern table 358 are passed as arguments from web server 280 to the program.

The program includes the following steps. At step 520, CPU 300 replaces, among the data of energy saving operation pattern displayed on energy saving operation pattern table 358, the energy saving operation pattern of the range designated by the start time and end time of the day of the week as designated by the arguments, by the energy saving operation pattern indicated by the energy saving pattern name. At step 522, CPU 300 outputs the header portion, based on the energy saving operation pattern data updated in this manner. At step 524, CPU 300 forms and outputs energy saving operation pattern table 358. At step 526, CPU 300 outputs the tail portion, and the program ends.

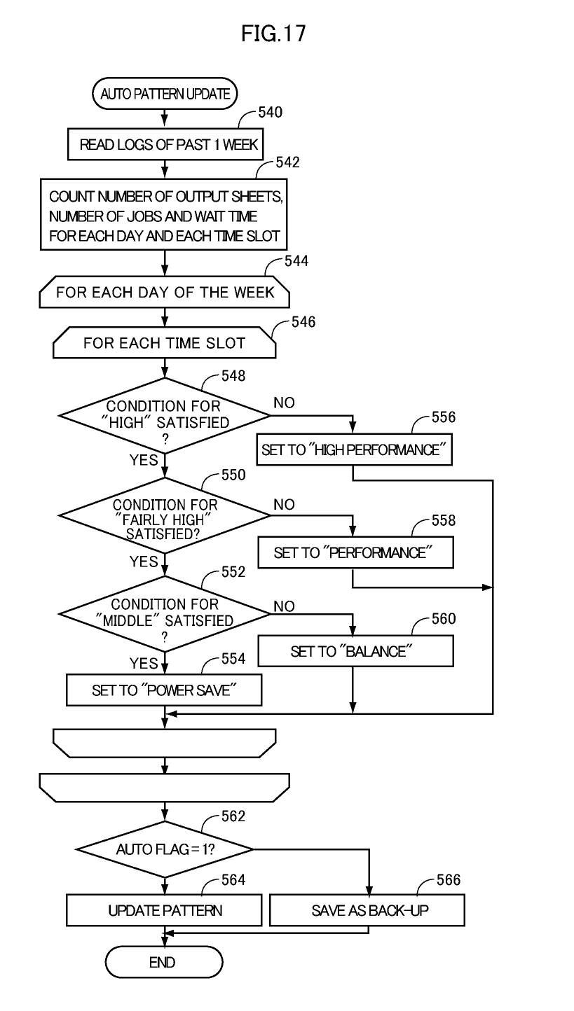

Referring to FIG. 17, the program realizing auto pattern updating unit 274 shown in FIG. 8 is periodically activated by a timer 276 shown in FIG. 8. In the present embodiment, even if the auto flag is 0, that is, if the operational mode is not for automatically learning the energy saving operation pattern from the working situation of image forming apparatus 100, the auto pattern updating process is executed and the results are saved. By such an approach, even if the apparatus is operating in the manual mode, the energy saving operation pattern updated in accordance with the actual working situation can be displayed, which may be used as a reference for the administrator when setting image forming apparatus 100.

The program includes the following steps. At step 540, CPU 300 reads all job logs of an immediately preceding prescribed time period, using date and time of job logs stored in log storage unit 272 as keys. At step 542, based on the job logs read at step 540, CPU 300 counts the number of output sheets of recording paper, the number of processed jobs and the total wait time of image forming apparatus 100 day by day of the week and hour by hour of the day, and calculates the operating rate. At step 544, CPU 300 repeats the following step 546 for each day of the week. At step 562, CPU 300 determines whether or not the auto flag stored in setting storage unit 282 (see FIG. 8) is 1. If the auto flag is 1, at step 564, CPU 300 updates the energy saving operation pattern stored in pattern storage unit 278 with the energy saving operation pattern formed at step 544, and the program ends. If the auto flag is 0, at step 566, CPU 300 additionally stores the energy saving operation pattern formed at step 544 as a back-up in user pattern storage unit 284, and the program ends. Though the energy saving operation pattern stored in user pattern storage unit 284 in this manner is one that is automatically learned, it can be handled in the similar manner as the user pattern.

The process executed at step 544 includes step 546. At step 546, CPU 300 repeatedly executes steps 548, 550, 552, 554, 556, 558 and 560 as will be described in the following, for each time of day of one day of the week.

At step 548, CPU 300 determines whether or not at least one of the number of output sheets, the number of jobs and the wait time counted for each time of day of one day of the week satisfies the condition of setting the operating rate to “high.” If it is determined at step 548 that the condition is satisfied, at step 556, CPU 300 sets the energy saving operation pattern (cell) identified by the day of the week and the time of day to “high performance” and terminates the process for the day of the week and the time of day. If it is determined at step 548 that the condition is unsatisfied, at step 550, CPU 300 determines whether or not at least one of the number of output sheets, the number of jobs and the wait time counted for each time of day of one day of the week satisfies the condition for setting the operating rate to “somewhat high.” If it is determined at step 550 that the condition is satisfied, the energy saving operation pattern (cell) identified by the day of the week and the time of day is set to “performance” and the process for the day of the week and the time of day is terminated. If it is determined at step 550 that the condition is not satisfied, at step 552, CPU 300 determines whether or not at least one of the number of output sheets, the number of jobs and the wait time counted for each time of day of one day of the week satisfies the condition for setting the operating rate to “middle.” If it is determined at step 552 that the condition is satisfied, at step 560, CPU 300 sets the energy saving operation pattern (cell) identified by the day of the week and the time of day to “balance” and terminates the process for the day of the week and the time of day. If it is determined at step 552 that the condition is not satisfied, at step 554, CPU 300 sets the energy saving operation pattern (cell) identified by the day of the week and the time of day to “power save” and terminates the process for the day of the week and the time of day.

[Operation]

Image forming apparatus 100 operates in the following manner. In the following description, among various functions of image forming apparatus 100, only the operation related to energy saving setting unit 260 will be described, and description related to operations of other common functions will not be repeated.

<Log Collection>

When image forming apparatus 100 is powered on, log obtaining unit 270 starts to collect job logs of image forming apparatus 100. Job logs are stored in job log storage unit 272.

<Automatic Pattern Updating Process>

Timer 276 counts time, and activates auto pattern updating unit 274 once every hour.

Referring to FIG. 17, auto pattern updating unit 274 obtains logs of immediately preceding prescribed time period (in the present embodiment, for one week) from log storage unit 272 (step 540), and executes the following process. First, based on the obtained job logs, auto pattern updating unit 274 counts the number of output sheets, the number of jobs and the wait time of image forming apparatus 100 day by day of the week and hour by hour of the day (step 542). From the results obtained by this process the operating rate can be calculated. Further, steps 548 to 554 are repeated for each day of the week from Monday to Sunday. By these processes, the energy saving operation pattern is set for each time of day of each day of the week.

Thereafter, at step 562, whether or not the auto flag is equal to 1 is determined. If the result is positive, the energy saving operation pattern stored in pattern storage unit 278 is updated by the newly calculated energy saving operation pattern (step 564), and the process ends. If the result at step 566 is negative, the newly calculated energy saving operation pattern is stored as a back-up pattern in user pattern storage unit 284 (step 566), and the process ends.

Through the above-described steps, the updating process of pattern storage unit 278 is completed.

<Display and Update of Energy Saving Operation Pattern>

When the user logs in, for example, from PC 190 for the administrator shown in FIG. 7 to image forming apparatus 100, a menu (not shown) for managing image forming apparatus 100 is displayed on the screen image of PC 190 for the administrator. The menu has an item “Display and Update of Energy Saving Operation Pattern.” If the user selects this item, the request is applied by web server 280 shown in FIG. 8 to display processing unit 286. Specifically, the program shown in FIG. 10 is activated.

Display processing unit 286 first reads various settings stored in setting storage unit 282 (step 330 of FIG. 10). The settings include the table for calculating the operating rate, the table for setting the energy saving pattern, the auto flag, and the energy saving operation pattern used at present. Thereafter, display processing unit 286 forms and outputs the header portion of energy saving setting screen image shown in FIG. 7 based on the read settings (step 332). The output is transmitted to PC 190 for the administrator through web server 280, and displayed by the web browser running on PC 190 for the administrator. At step 334, display processing unit 286 reads the energy saving operation pattern that is currently executed from pattern storage unit 278 (step 334). In accordance with the read energy saving operation pattern, at step 336, the display of energy saving operation pattern table 358 is formed and output. This display is also transmitted to PC 190 for the administrator through web server 280, and the browser of PC 190 for the administrator additionally displays this on the screen image. As a result, on a browser window of PC 190 for the administrator, the header portion and energy saving operation pattern table 358 (see FIG. 11) are displayed. Further, display processing unit 286 outputs the tail portion. This display is also transmitted to the browser of PC 190 for the administrator through web server 280, and displayed. As a result, a screen image such as shown in FIG. 11 is displayed on PC 190 for the administrator.

When the display data is formed, display processing unit 286 displays mode selection radio button 354 and pull-down list 356 for setting user pattern name, in accordance with the settings. Check box 360 is not checked, and pull-down list 362 for selecting the energy saving mode, pull-down list 364 for selecting the day of the week, start-time pull-down list 366, end-time pull-down list 368, and table update button 370 are not active but grayed-out.

Operations that can be made by the user on the energy saving setting screen image include: (A) switching between auto mode and manual mode (mode switch); (B) edition and saving of user pattern; (C) change (registration) of energy saving operation pattern set in image forming apparatus 100. These will be described in the following.

(A) Mode Switch

When the mode to be used is switched, the user presses the radio button of the selected mode among mode selection radio buttons 354. If the selected mode is the manual mode, which pattern is to be used is selected, using pull-down list 356 for setting the user pattern name.

When the user presses update button 352, update processing unit 288 shown in FIG. 8 is activated, and energy saving operation pattern table 358 is updated in the following manner.

Referring to FIG. 15, at step 480, whether the selected mode is the auto mode or not is determined. If the result is positive, the energy saving pattern that is currently executed is read from pattern storage unit 278, and if the result is negative, the user pattern designated by pull-down list 356 for setting the user pattern name is read from user pattern storage unit 284.

After steps 482 and 486, the control flows are merged. At step 488, the header portion is output, energy saving operation pattern table 358 is output in accordance with the read pattern at step 502, the tail portion is output at step 504, and the process ends.

Through these process steps, when the auto mode is designated, the energy saving operation pattern learned from the logs is displayed on energy saving operation pattern table 358, and when the manual mode is selected, the designated user pattern is displayed on energy saving operation pattern table 358.

(B) Edition and Saving of User Pattern

While the energy saving operation pattern schedule is displayed on energy saving operation pattern table 358, if the user clicks check box 360, the check box 360 is checked. Consequently, pull-down list 362 for selecting the energy saving mode, pull-down list 364 for selecting day of the week, start-time pull-down list 366, end-time pull-down list 368 and table update button 370 are activated. This process is executed not on the server side but on the side of web browser of the client.

The user designates the day of the week of the cell of which setting is desired, among the cells displayed on energy saving operation pattern table 358, by using pull-down list 364 for selecting day of the week, and designates the time of day by start-time pull-down list 366 and end-time pull-down list 368. The user sets the energy saving pattern to be set to the designated cell, using pull-down list 362 for selecting the energy saving mode. When table update button 370 is pressed, a table update request is transmitted to web server 280, and the process for updating the table is executed in accordance with the user input. Specifically, table update processing unit 294 shown in FIG. 8 is activated, and the program shown in FIG. 16 is executed.

Referring to FIG. 16, of the data displayed on energy saving operation pattern table 358 at present, to the cell of the day of the week and the time of day as designated by the user input, a value indicating the designated energy saving operation pattern is input (step 520). Thereafter, at steps 522, 524 and 526, the screen image shown in FIG. 11 is again formed in accordance with the values as modified, and it is displayed on the browser of the client through web server 280.

When the user repeats the process described above and finishes forming the desired pattern, the user has the user pattern stored in user pattern storage unit 284. For this purpose, the user inputs a desired user pattern name in pattern name field 372, and presses save button 374 shown in FIG. 11. As a result, the user pattern saving request is transmitted to web server 280, and user pattern saving processing unit 292 is activated. User pattern saving processing unit 292 executes the program shown in FIG. 14. In pattern name field 372, the user pattern name corresponding to the pattern displayed on energy saving operation pattern table 358 is displayed as a default.

Referring to FIG. 14, whether or not the user pattern having the same name as the user pattern name input by the user is stored in user pattern storage unit 284 is determined (step 450). If the result is positive, the user pattern of the same name stored in user pattern storage unit 284 is updated by the user pattern input by the user (step 452). If the result of step 450 is negative, the new user pattern is added to user pattern storage unit 284 (step 454), and the user pattern name designated by the user is saved in the index of user pattern storage unit 284 (step 456).

After steps 452 and 456, the control flows are merged. Thereafter, the pattern updated at step 452 or the pattern added at step 454 is read from user pattern storage unit 284 (step 458), and through steps 460, 462 and 464, the energy saving setting screen image is formed in accordance with the pattern and displayed on the browser of PC 190 for the administrator. Then, the process ends.

Through the above-described process steps, edition and saving of the user pattern are completed.

(C) Setting of Energy Saving Operation Pattern

If the pattern called by update button 352 is to be set in image forming apparatus 100, the user presses registration button 350. As a result, a pattern registration request is transmitted to web server 280 shown in FIG. 8, and registration processing unit 290 is activated. Registration processing unit 290 executes the program shown in FIG. 13.

Referring to FIG. 13, in the registration process, whether or not the energy saving operational mode designated by the user is the auto mode is determined (step 420). If the result is positive, the auto flag stored in setting storage unit 282 is updated to 1 (step 422), and the auto pattern updating process shown in FIG. 17 is executed (step 424). If the result of step 420 is negative, the auto flag is updated to 0 (step 426), the user pattern designated by the user is written in pattern storage unit 278 (step 428), and the pattern name of the written pattern is saved as the name of the pattern executed at present, in setting storage unit 282.

After steps 424 and 430, the control flows are merged. Thereafter, the pattern that is currently executed is read from pattern storage unit 278 (step 432), through steps 434, 436 and 438, the energy saving setting screen image (FIG. 11) is formed in accordance with the pattern and transmitted to the client, and the process ends.

### Effects of the Present Embodiment

As described above, in image forming apparatus 100 in accordance with the present embodiment, the energy saving operation pattern is automatically updated based on logs, and in addition, the pattern can be confirmed on a screen image. Therefore, it is possible for the administrator to know according to what pattern the image forming apparatus 100 is operating, and hence, it is possible to effectively manage image forming apparatus 100. Further, it is possible to switch and use the automatically learned pattern and the pattern formed by the user. Therefore, if the pattern learned from past job logs is considered to be ineffective, such as in the case when the installation location of image forming apparatus 100 is changed, setting of image forming apparatus 100 can be done manually. Thus, operation of image forming apparatus in accordance with a pattern not matching the actual working situation can be prevented. Further, if the auto mode is set after a prescribed period of operation, image forming apparatus 100 can operate in accordance with the energy saving operation pattern reflecting the actual working situation of the new department.

Therefore, the energy consumed by image forming apparatus 100 can be reduced, taking into consideration the working situation. Further, since the energy saving operation pattern of image forming apparatus 100 is set in accordance with the working situation, the user who is about to use the image forming apparatus 100 will not be kept waiting for a long time, and hence, efficiency of business operation can be improved.

### Modification

In the embodiment above, the operating rate is calculated by comparing predetermined threshold values with values obtained from job logs. The present invention, however, is not limited to such an embodiment. By way of example, values obtained from job logs may be input to a certain calculation equation to calculate the operating rate as a numerical value, and the numerical value may be compared with a predetermined threshold value to determine the energy saving pattern.

Such an example will be discussed in the following. In the present modification, the operating rate w (0≦w≦1) is calculated in accordance with Equation (1) below.

$$\begin{matrix}Equation ( 1 ) & \\ w = α \frac{{p}_{out}}{M} + β g ( \frac{{P}_{jobs}}{N} ) + γ \frac{60 - {p}_{ready}}{60} & ( 1 )\end{matrix}$$

where the variables mean:

Pout: number of output sheets/hour

Pjobs: number of jobs/hour

Pready: wait time [min]/hour

M: output capability of apparatus/hour

N: job threshold value (for example, N=30)

α, β, γ: weight coefficients, α+β+γ=1

g(x)=1(x≧1)
=x(x<1).

In this manner, based on the value of operating rate w calculated for each combination of the day of the week and time of day, the energy saving pattern of the corresponding cell is determined in accordance with Table 3 below.

TABLE 3

| Pattern name | Operation | Operating rate |
|---|---|---|
| High performance | Enter preheat mode | 0.5 ≦ w |
| | after 1 hour | |
| Performance | Enter preheat mode | 0.3 ≦ w < 0.5 |
| | after 30 minutes | |
| Balance | Shut off after 5 minutes | 0.1 ≦ w < 0.3 |
| Power save | Shut off in shortest | w < 0.1 |
| | period after job end | |

By such an approach also, similar effects as the embodiment above can be attained.

It may be the case that power of image forming apparatus 100 is turned off at night at some department. In that case, the logs of these hours cannot be obtained. Therefore, in that case, the energy saving operation pattern of these hours cannot be determined in the auto mode. As a solution to such a problem, a default energy saving operation pattern may be determined in advance, and the default energy saving operation pattern may be allocated for the hours when the logs cannot be obtained. Typically, it may be appropriate to use the “power saving” operational mode as the default mode. That the log cannot be obtained means operation of image forming apparatus 100 in these hours is substantially unnecessary.

Here, in energy saving operation pattern table 358 shown in FIG. 11, the display of the hour or hours to which the default mode is allocated may be made different from other portions (for example, may be displayed in gray). Alternatively, the same display of the energy saving pattern which is used as the default mode may be used. It would be convenient if these manners of display can be switched.

In the above-described embodiment, confirmation and setting of energy saving operation pattern are executed from PC 190 for the administrator outside of image forming apparatus 100, through web server 280 in image forming apparatus 100. Setting of energy saving operation pattern of the present embodiment may be done in the similar manner, using touch-panel display 130 of image forming apparatus 100, as described above.

In the embodiment described above, learning and setting of energy saving operation pattern are done on the basis of day by day of the week and hour by hour of the day as a unit time slot. The present invention, however, is not limited to such an embodiment. By way of example, a shorter time period or longer time period may be used for the time slot. The time slot may have different length. For instance, management may be done on hour-by-hour basis during daytime, and three-hours by three-hours at night. Different units may be used for the time slots for the user pattern and for the pattern learned automatically. The unit of schedule of the energy saving operation pattern is not limited to the week. A longer unit such as a month, or a shorter unit such as a day may be used.

Though the default value of auto flag has been set to 1, naturally, the value may be set to 0. Further, it may be possible to allow the user to freely set the auto flag value to 1 or 0.

The setting of each cell of Table 50 is distinguished by color in the embodiment described above. The present invention, however, is not limited to such an embodiment. The energy saving operation pattern may be distinguished by characters, figures, icons or the like.

Though an example in which energy saving operation pattern table 358 as a whole is displayed on the screen has been described, part of energy saving operation pattern table 358 may be displayed in an up/down scrollable manner, considering a screen of low height. The table may be given in day-by-day or hour-by-hour tab display, and the display may be switched on the screen image. It is preferred, however, that the display is in 24 hours/one week unit such as shown in FIG. 11, since it is easy to visually recognize the contents.

In the embodiment above, the energy saving operation pattern is divided to four stages in accordance with the operating rate. The present invention, however, is not limited to such an embodiment. The pattern may be divided to a larger number of stages, or a smaller number of stages. Further, the operating rate may be calculated as a numerical value as in the modification above, and the time until the preheat mode starts may be changed continuously as a function of the numerical value.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An image forming apparatus, comprising:
a transition time determining unit determining, based on working situation of said image forming apparatus at an installation location, transition time of each time slot of a day for making a transition from a normal conduction state to a power saving state; and
a display control unit displaying the status of each time slot determined by said transition time determining unit, slot by slot on a display device.

2. The image forming apparatus according to claim 1, wherein said display device is a display device of external equipment communicable with said image forming apparatus.

3. The image forming apparatus according to claim 1, further comprising an operation display panel; wherein
said display device is said operation display panel.

4. The image forming apparatus according to claim 1, wherein
said transition time determining unit includes a selection determining unit determining said transition time of each time slot to one selected from a predetermined plurality of time periods, based on the working situation of said image forming apparatus at the installation location; and
for a time slot for which said transition time cannot be determined by said selection determining unit, the shortest time period among said plurality of time periods is determined to be said transition time.

5. The image forming apparatus according to claim 1, wherein said display control unit displays the determined status of each time slot in color-coded manner.

6. The image forming apparatus according to claim 1, further comprising a post-display changing unit for changing, after said transition time determined by said transition time determining unit is displayed by said display control unit, said transition time of each time slot in accordance with a user operation.

7. The image forming apparatus according to claim 1, further comprising a changing unit for changing said transition time of each time slot.

8. A method of managing power saving setting of an image forming apparatus, comprising the steps of:
determining, based on working situation of said image forming apparatus at an installation location, transition time of each time slot of a day for making a transition from a normal conduction state to a power saving state; and
displaying the status of each time slot determined at said transition time determining step, slot by slot on a display device.

9. The method of managing an image forming apparatus according to claim 8, wherein said display device is a display device of external equipment communicable with said image forming apparatus.

10. The method of managing an image forming apparatus according to claim 8, wherein
said image forming apparatus further includes an operation display panel; and
said display device is said operation display panel.

11. The method of managing an image forming apparatus according to claim 8, wherein
said step of determining said transition time includes the step of determining said transition time of each time slot to one selected from a predetermined plurality of time periods, based on the working situation of said image forming apparatus at the installation location; and
for a time slot for which said transition time cannot be determined at said step of determining to selected one, the shortest time period among said plurality of time periods is determined to be said transition time.

12. The method of managing an image forming apparatus according to claim 8, wherein at said step of displaying on said display device, the determined status of each time slot is displayed in color-coded manner.

13. The method of managing an image forming apparatus according to claim 8, further comprising the step of changing, after said transition time determined at said transition time determining step is displayed at said displaying step, said transition time of each time slot in accordance with a user operation.

14. The method of managing an image forming apparatus according to claim 8, further comprising the step of changing said transition time of each time slot.
